(19) United States
(12) Patent Application Publication
(10) Pub. No.: US 2007/0041723 A1
(43) Pub. Date: Feb. 22, 2007

(54) Elongated camera system for cellular telephones

(76) Inventors: Roman C. Gutierrez, Arcadia, CA (US); Tony K. Tang, Glendale, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/209,012

(22) Filed: Aug. 22, 2005

(51) Int. Cl. G03B 3/10

(52) U.S. Cl. 396/351

(57) ABSTRACT

A compact camera for a cellular telephone is disclosed. A reflector is used to bend a light path of the camera, so as facilitate the use of a longer optical path in thin cellular telephones, while allowing pictures to be taken from the front of the camera. The camera comprises a lens, a imager, and a reflector. The lens, the imager, and the reflector cooperate to define an optical path that is longer than a thickness of the cellular telephone. The use of a longer optical path facilitates the use of optical elements for such functions as variable focusing, zoom and/or image stabilization.

### TECHNICAL FIELD

The present invention relates generally to optics. The present invention relates more particularly to a camera for a cellular telephone, wherein the camera has an elongated optical path that accommodates enhanced optics and wherein the camera is configured to take pictures in a direction along a shorter axis of the cellular telephone.

### BACKGROUND

Camera phones are well known. The cameras of contemporary camera phones have an optical axis that is perpendicular to the face of the telephone, i.e., across the thickness of the telephone. Therefore, there is little room available for non-essential optical components.

Because of the space limitations associated with the configuration of contemporary camera phones, features such as variable focus, zoom, and image stabilization are not provided. There is not enough room to position the necessary optical elements along the thickness of a cellular telephone.

Further, there is an ongoing effort to make cellular telephones thinner. As cellular telephone become thinner, even less room is available for such non-essential optical elements.

However, such features as variable focus, zoom, and image stabilization are desirable. The use of variable focus provides better low light performance by eliminating the requirement for the stopped down aperture that fixed focus cameras need in order to obtain the necessary depth of field. It also tends to provide better focus. The use of an optical zoom eliminates the image degradation associated with the use of digital zoom, thus providing higher quality for magnified images. The use of image stabilization mitigates the problem of image blurring commonly associated with taking pictures while hand holding the camera phone, especially when longer exposure times are used.

However, as mentioned above, the addition of the optical elements needed to provide such features requires the use of an optical path that is longer than the thickness of a contemporary cellular telephone. Thus, such features are absent in contemporary camera phones, where the optical axis is across the thickness thereof.

In view of the foregoing, it is desirable to provide a camera phone that has features such as variable focus, zoom, and/or image stabilization. In this manner, image quality can be substantially enhanced.

### BRIEF SUMMARY

A compact camera for a cellular telephone is disclosed. A reflector is used to bend a light path of the camera, so as facilitate the use of a camera having a longer optical path in thin cellular telephones, while allow pictures to be take from the front of the telephone.

More particularly, the camera comprises a lens, a imager, and a reflector. The lens, the imager, and the reflector cooperate to define an optical path that is longer than a thickness of a cellular telephone.

According to one embodiment, light for the camera enters the cellular telephone through a window formed in the face thereof, such as above the keys and/or display. The light is then reflected such that it travels along an optical axis that is generally parallel to the long axis of the telephone. Since the light path is along an optical axis that is parallel to the long axis of the telephone, it can be substantially longer than the thickness of the telephone. Various different combinations of optical elements can be disposed along the optical axis, so as to effect desired operations upon the incoming light.

For example, the use of a longer optical path facilitates the incorporation of optical elements that effect variable focusing (autofocusing), zoom and/or image stabilization. The bending of the optical path allows a camera having these desirable features to obtain images through the front of the cellular telephone. That is, such a camera can be aimed by pointing the face (that surface having the keys and/or display) toward a scene to be imaged. Thus, for example, the camera can more readily be used to image a person using the cellular telephone.

This invention will be more fully understood in conjunction with the following detailed description taken together with the following drawings.

### BRIEF DESCRIPTION OF THE DRAWINGS

FIG. 1 is a semi-schematic, fragmentary, side view showing a cellular telephone having a conventional camera (which lacks variable focus, zoom and image stabilization features) that is configured so as to take pictures from a front or face of a cellular telephone, according to contemporary practice; and

FIG. 2 is a semi-schematic, fragmentary, side view showing a cellular telephone having an elongated camera (which can have variable focus, zoom and/or image stabilization) that is configured so as to take pictures from a front or face of a cellular telephone, according to an exemplary embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION OF THE INVENTION

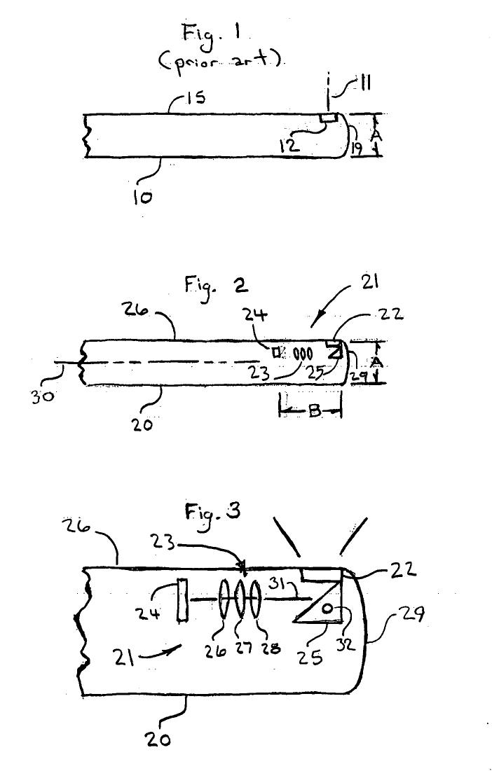

Referring now to FIG. 1, a cellular telephone 10 comprises a contemporary camera 12 that is configured to take pictures through a front or face 15 of the cellular telephone 10. Contemporary camera 12 comprises a fixed focus camera that does not have variable focus, zoom or image stabilization features, as discussed above. Thus, contemporary camera 12 generally comprises only an imaging sensor and a single fixed focus lens. Since contemporary camera 12 lacks the components for variable focus, zoom and image stabilization, it readily fits into cellular telephone 10 with its optical axis 11 perpendicular to the face 15 thereof.

However, it is worthwhile to appreciate that the thickness (Dimension A) of cellular telephone 10 limits the length of an optical path of camera 12, since camera 12 is disposed within cellular telephone 10 with its optical path generally perpendicular to the face 15 of cellular telephone 10 (thus making the optical path extend along axis 11, i.e., across the thickness of cellular telephone 10). Thus, the optical path of a conventional camera that is disposed within a cellular telephone such that it can take pictures through the face thereof is generally limited to a length that is less than the thickness (Dimension A) of cellular telephone 10. Of course, such limitation on the length of the optical path limits the amount and type of optical components that can be placed along the optical path.

On way to facilitate the use of additional optical components, such as those necessary for variable focus, zoom, and/or image stabilization, is to configure the optical axis along a length of cellular telephone 10, such that the camera takes picture through an end 19 of cellular telephone 10. However, it is not always desirable to take pictures through the end of a cellular telephone. For example, it is at least occasionally desirable for a cellular telephone user to take self-portraits, such that others can see the user.

With some cellular telephones it is possible to sit the telephone upon a surface such that the face of the telephone is pointed toward the user. Thus, a camera that is configured to take pictures along optical axis 11 can be use to take such pictures while the cellular telephone is being used to make a telephone call. In such situations, it is generally easier to take such self-portraits with a camera that takes pictures through the face 15 of the telephone instead of through end 19 thereof.

One exemplary embodiment of the present invention is illustrated in FIGS. 2 and 3. According to this embodiment, a light path of the camera is bent such that pictures can be taken thought the face of the cellular telephone, instead of through an end thereof. By bending the light path of the camera, the length of the light path can be substantially increased. This increase in the length of the light path provides sufficient room to facilitate the use of additional optical components for such features as variable focus, zoom, and image stabilization.

Referring now to FIG. 2, a cellular telephone 20 has a built-in camera 21 that is configured to take pictures through a face 15 thereof. Camera 21 is elongated such that it extends along a substantial portion of the length of cellular telephone 20. As discussed above, elongation is facilitated by bending the optical path thereof. Such elongation facilitates the use of optical elements that enhance or otherwise modify operation of camera 21.

Light enters cellular telephone 20 via a window 22 formed in a front or face 33 thereof. Window 22 can be either a mere window (such as by having plano-plano surfaces) or can be a lens (such as by having at least one surface that is curved). The light entering window 22 is reflected by reflector 25 such that it travels along an optical axis 31 (FIG. 3) of camera 21 that is substantially parallel to a longitudinal axis 30 of cellular telephone 20. Thus, the path for light used by camera for imaging is bent. In this manner, a longer camera (having a longer light path) can be used while still permitting pictures to be taken through a face 33 of the camera. It can easily be appreciated that the length (Dimension B) of the light path of camera 21 can be substantially greater than the thickness (Dimension A) of cellular telephone 10.

Reflector 25 can be a mirror, a prism reflector, a beam splitter, a diffraction grating or any other desired type of reflector. Reflector 25 can be a deformable mirror, so as to correct for aberrations elsewhere within the camera optics and/or outside of the camera (such as in the atmospheres) or to provide other desired effects. After light is reflected by reflector 25, it travels through lens assembly 23 to imaging sensor 24. Lens assembly 23 comprises optical components that facilitate such features as variable focus, zoom, and/or image stabilization.

Mirror 25 can be moved or deformed so as to effect panoramic or other desired exposures or effects. For example, mirror 25 can be rapidly moved to a series of consecutive positions to provide a series of consecutive exposures that define a panorama.

Such optical elements as lenses 26, 27, and 28 can be configured to effect variable focus, zoom, and/or image stabilization. Thus, one or more of lens 26, 27, and 28, can move so as to effect focus (either manual focus or autofocus), zoom, and/or image stabilization. These optical components are generally dispose along optical path 31 of elongated camera 21. Since the light path of camera 21 is bent, such optical components can be used without necessitating that pictures be taken though the end 29 of cellular telephone 20. Thus, self- portraits, for example, can easily be taken. Indeed, a variety of other optical elements, such as polarizers, filters, and diffraction gratings can be accommodated by the elongated optical path of a camera formed according to one or more aspects of the present invention.

Optionally, reflector 25 can be moved, such as by pivoting it using pivot 32. Pivot 32 can be either manually operated or motor driven. In this manner, pictures can be taken in directions other than perpendicular to face 33 of cellular camera 20. Thus, if it is desirable to take pictures though end 29 of cellular camera 20, reflector 25 can be repositioned so as to facilitate doing so. At least some of end 29 of cellular camera 29 can be transparent to facilitate the taking of pictures with reflector 25 so repositioned.

Reflector 25, lens assembly 23, lenses 26, 27, 27, imager 24 and/or any other component of camera 21 can be moved so as to effect image stabilization, if desired. For example, reflector 25 can be rotated and/or translated so as to effect image stabilization.

Although this description refers to the face of a cellular telephone, the camera can similarly be configured to take pictures through the back of a cellular telephone. Indeed, because of its compact configuration, the camera can be oriented so as to take pictures from any desired surface of a cellular telephone, including the sides and ends thereof.

Generally, when described as taking pictures through the face of the cellular telephone, the camera can be assumed to be taking pictures along an optical axis that is generally perpendicular to the face of the cellular telephone. However, this does not have to be the case. Pictures can be taken through the face of the camera at any desired angle, including angles other than 90 degrees with respect to the face of the telephone. Indeed, the reflector can be movable so as to facilitate the taking of pictures along an axis at various angles with respect to the face of the camera, as well as at various angles with respect to other surfaces of the camera through which pictures can be taken.

The bending of the light path via reflector 25 and the consequent elongation of the light path (along the length of the cellular telephone, for example) facilitates separation of the components within the camera, thus enabling new camera designs that are not achievable using contemporary camera configurations. Such new camera designs can provide unique functions that are useful in a variety of different applications.

Moreover, bending the light path facilitates fitting cameras into smaller structures. For example, a camera could be disposed within an antenna (such as the antenna of a cellular telephone) and proximate the tip thereof or proximate the tip of some other structure that can pop out of a housing somewhat like a periscope. In such instances, the reflector can rotate and obtain substantially a 360 degree, unobstructed panoramic picture of its surroundings. This is possible since the light path is bent so that the camera can fit within the limited space available in an antenna or other similar elongated structure.

Further, by providing a camera within an antenna or other elongated, telescoping, and/or extendable structure, the camera can be used to image hard to reach places. For example, the camera can be inserted though a spark plug hole to image the cylinder walls of an engine or inserted into a hole in a wall of a home to search for evidence of pests. As such, the present invention has a variety of different applications in such diverse areas as auto mechanics and home construction/maintenance.

Because of its thin configuration, the elongated camera of the present invention is suitable for use in a variety of different personal electronic devices such as cellular telephones, personal digital assistants (PDAs), laptop computers, notebook computers, pocket PCs, and the like.

Embodiments described above illustrate, but do not limit, the invention. It should also be understood that numerous modifications and variations are possible in accordance with the principles of the present invention. Accordingly, the scope of the invention is defined only by the following claims.

1. A camera for a cellular telephone comprising a reflector configured to bend a light path thereof.

2. A camera for a cellular telephone comprising a reflector configured to define a light path along a longer axis of the cellular telephone while facilitating imaging in a direction along a shorter axis of the cellular telephone.

3. A camera for a cellular telephone, the camera comprising an optical path defined at least partially by a reflector such that a length of the optical path is greater than a thickness of a cellular telephone within which the path is defined.

4. A camera comprising:
a lens;
an imager;
a reflector; and
wherein the lens, the imager, and the reflector cooperate to define an optical path that is bent, so as to increase a length of the optical path while allowing the camera to fit within a thinner enclosure than a camera lacking the reflector would fit within.

5. The camera as recited in claim 4, wherein the lens, the imager, and the reflector are configured to fit within a personal electronic device.

6. The camera as recited in claim 4, wherein the lens, the imager, and the reflector are configured to fit within a cellular telephone.

7. The camera as recited in claim 4, wherein the lens, the imager, and the reflector are configured to fit within a cellular telephone antenna.

8. The camera as recited in claim 4, further comprising a window through which ambient light enters the cellular telephone and is subsequently incident upon the reflector.

9. The camera as recited in claim 4, further comprising a window through which ambient light enters the cellular telephone, the window having at least one curved surface.

10. The camera as recited in claim 4, wherein the lens is a focusing lens for the camera.

11. The camera as recited in claim 4, wherein the lens is a zoom lens for the camera.

12. The camera as recited in claim 4, wherein the lens is part of a lens assembly that comprises a plurality of lenses.

13. The camera as recited in claim 4, wherein the reflector is a mirror.

14. The camera as recited in claim 4, wherein the reflector is a prism reflector.

15. The camera as recited in claim 4, further comprising a filter disposed within the optical path.

16. The camera as recited in claim 4, further comprising a polarizer disposed within the optical path.

17. The camera as recited in claim 4, wherein the reflector is deformable.

18. The camera as recited in claim 4, wherein the reflector is movable so as to facilitate taking of picture in a plurality of different directions with respect to the cellular telephone.

19. The camera as recited in claim 4, wherein the reflector is a beam splitter.

20. A camera for a cellular telephone, the camera comprising:
focusing means;
imaging means; and
reflecting means;
wherein the focusing means, imaging means, and the reflecting means cooperate to define an optical path that is longer than a thickness of a cellular telephone.

21. A cellular telephone having a camera, the camera comprising:
a lens;
a imager; and
a reflector;
wherein the lens, the imager, and the reflector cooperate to define an optical path that is longer than a thickness of a cellular telephone.

22. A method for making a cellular telephone, the method comprising:
assembling a camera within the telephone such that an optical path of the camera is longer than a thickness of the cellular telephone; and
wherein the camera is configured to facilitate imaging in a direction that is generally perpendicular to a face of the telephone.

23. A method for operating a camera of a cellular telephone, the method comprising:
pointing the cellular telephone toward a scene to be imaged, the scene being in a direction that is generally perpendicular to a face of the camera; and
imaging the scene with an imager that is oriented so as to receive light along an optical path that is generally parallel to the face of the camera.

24. A method for panoramic imaging, the method comprising rotating a reflector so as to image different portions of a panoramic scene, the reflector being configured to bend a light path of the camera.
